(19) United States
(12) Patent Application Publication
(10) Pub. No.: US 2005/0160918 A1
(43) Pub. Date: Jul. 28, 2005

(54) Apparatus for making brewed coffee and the like

(76) Inventors: Peter Winstanley, Roswell, GA (US); Holly Smith-Berry, Fulton, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/985,422

(22) Filed: Nov. 11, 2004

Related U.S. Application Data
(63) Continuation-in-part of application No. PCT/US04/13725, filed on May 3, 2004.
(60) Provisional application No. 60/468,115, filed on May 2, 2003.

(51) Int. Cl. A47J 31/00

(52) U.S. Cl. 99/279

(57) ABSTRACT

An apparatus for brewing ground, brewable foodstuffs having a water reservoir, a boiler, and a flow meter all connected in a common fluid path with a pump that produces a fluid pressure in the common fluid path. A pod holder capable of receiving a pod formed of filter material and containing a mass of ground, brewable foodstuffs having a sieved bottom is located so as to receive the metered volume of water from the common fluid path. In turn, an interchangeable or pivotally mounted fluid conduit is positioned to receive fluid passing through the sieved bottom and to convey the fluid into one or more cups. With this apparatus a small quantity of a brewed liquid, such as coffee, can be produced in a relatively short brewing period with a pleasing taste profile. The fluid pressure may also be adjusted so as to enhance the creation of a crema layer in a coffee drink.

### RELATED APPLICATION DATA

The present application is a continuation-in-part of PCT application No. PCT/US04/13725 filed May 3, 2004 and claims priority to U.S. Ser. No. 60/468,115 filed May 2, 2003, which applications are incorporated herein by reference to the extent permitted by law.

### BACKGROUND OF THE INVENTION

1. Technical Field

The invention relates to kitchen appliances generally and, in particular to an apparatus for brewing coffee.

2. Related Art

Coffee drinkers are often a picky lot. It is difficult to speak in terms of likes and dislikes for the coffee consuming public. People in the coffee industry often look at the extraction rate for a particular combination of coffee variables (including blend, grind, moisture and roast color). “Extraction rate” is the amount of soluble solids that pass from coffee beans to brewed coffee and give it body and flavor. Coffee may be thin or “underextracted,” meaning that not enough soluble solids came out. Harshly potent coffee is referred to as “overextracted,” meaning that too many soluble solids came out.

The extraction rate also depends on the type of coffee maker used. Among other variables, the water temperature (the ideal water temperature is about 195 to 205 degrees F.—not a rolling boil, otherwise bitter substances will be extracted), water pressure, blend, the grind type, the filter type and the contact time between water and ground all figure into the extraction rate. This may explain why there are so many different types of coffee makers, such as electric drip, moka, Napoletana, percolators, expresso and French presses.

Drip coffee is the most common home-brewing method in which hot water drips through ground coffee at the force of gravity. Electric drip is the most common form of coffee maker. “Mokas” use steam pressure (about 3.5 bars) from boiling water in a closed chamber to force the hot water to escape from the chamber and pass through ground coffee to produce coffee. Because of the steam temperatures, mokas tend to make bitter coffee. They also tend to require the brewing of multiple cups of coffee rather than a single cup. A “napoletana” has an lower chamber for boiling water and an upper chamber with a spout and in between a ground coffee compartment. After water boils in the lower chamber, the pot is flipped over and the water drips through the ground coffee into the part with a spout. Napoletanas are messy and result in a strong cup of coffee. “Percolators” recycle boiling water through ground coffee filtered through a perforated metal or even a ceramic screen, producing a bitter, sour brew. “French presses” steep the coffee grounds in water, like tea leaves, then a finely perforated metal screen is pressed down through the liquid to separate the grounds from the brewed coffee. This results in strong often bitter coffee taste profile.

Espresso is a popular type of coffee. “Espresso” is a method of brewing coffee by forcing hot water at very high pressure (approximately 9 bars) through finely ground coffee, producing a syrupy texture and a powerful, sweet taste. Generally only a “pump machine” produces true espresso at home. Pump machines have a small electric pump produce high pressure to force hot water through finely ground coffee. “Steam machine” which rely on pressure from built up steam in the fluid path—are also generally billed as espresso makers but may not produce sufficient pressure (9 bars) for true espresso. These very high pressure requirement make manufacturing espresso machines expensive. Larger pumps and reenforced fluid paths, boilers, etc. are required to ensure safety and reliability. However, espresso machines frequently allow users to make one or two small cups of espresso quickly with a pleasing strong taste and crema. “Crema” is the a golden foam made up of oil and colloids that floats atop the surface of a perfectly brewed cup of espresso. Achieving crema depends on a number of factors, but most importantly the degree of pressure used in brewing. Some machines achieve sufficient pressure by mixing the coffee liquid with air after brewing by forcing it through a tiny opening.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is an elevational, perspective view of the apparatus for brewing ground, brewable foodstuffs.

FIG. 2 is a schematic diagram of the fluid path in the coffee brewing apparatus.

FIG. 3 is a front elevational view of the top of the apparatus in a open position.

FIG. 4 is an exploded, perspective view of the pod holder assembly of the coffee brewing apparatus.

FIG. 5 is a side elevational view of the pod cup portion of the pod holder assembly shown in FIG. 4.

FIG. 6 is a top view of the pod cup portion of the pod holder assembly of the coffee brewing apparatus shown in FIG. 5.

FIG. 7 is a elevational, perspective view of the fluid cup portion of the pod holder assembly of the coffee brewing apparatus shown in FIG. 5.

FIG. 8 is a cross sectional view of the fluid cup of FIG. 7 taken along line 8-8.

FIG. 9 is a top plan view of the fluid cup portion of the pod holder assembly of the coffee brewing apparatus shown in FIG. 5.

FIG. 10 is a cross-sectional view of the fluid nozzle portion of the pod holder assembly of the coffee brewing apparatus shown in FIG. 5.

FIG. 11 is a side, elevational view of a preferred coffee pod for use in the apparatus for brewing coffee and other hot beverages.

FIG. 12A is a top plan view of the coffee pod of FIG. 11.

FIG. 12B is a perspective, partial cross sectional view of the bottom of the coffee pod of FIG. 11.

FIG. 13 is a perspective view of the top part of an alternative embodiment of a fluid nozzle.

FIG. 14 is a front view of the opening in the housing of an alternative embodiment of the brewing apparatus in which a fluid cup may be placed.

FIG. 15 illustrates a pivotally mounted fluid nozzle as described in an alternative embodiment of the invention.

### DETAILED DESCRIPTION OF THE EXEMPLARY EMBODIMENTS

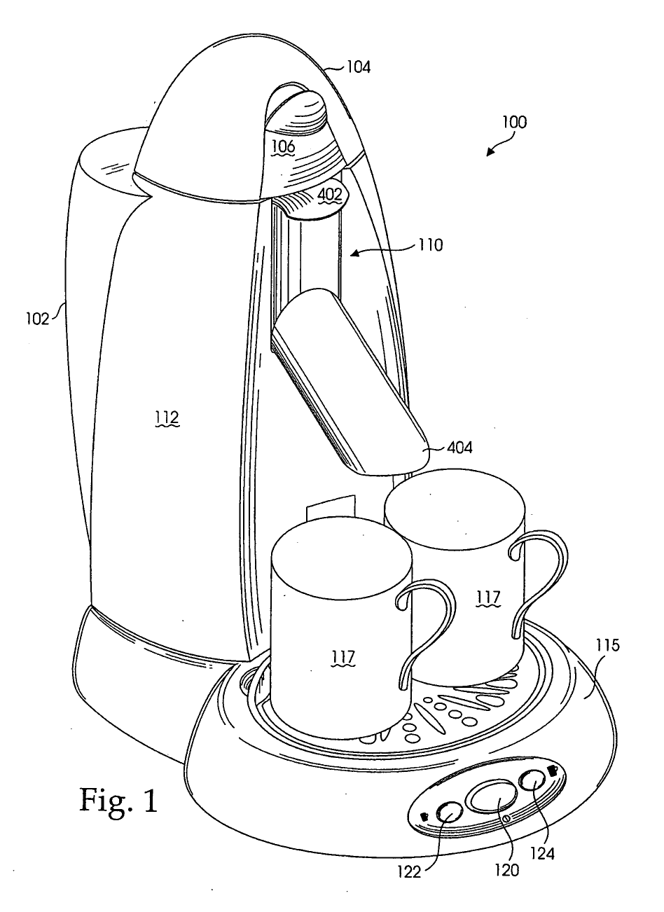

FIG. 1 is an elevational, perspective view of a preferred embodiment of an apparatus for brewing ground, brewable foodstuffs (such as coffee and tea). As shown, apparatus 100 has a water reservoir 102 to store water for brewing the ground foodstuffs, a brewhead 104 with a mechanical latch 106, and a pod holder assembly 110 that is capable of receiving a pod containing ground foodstuffs. The pod holder assembly 110 is supported by housing 112, which also preferrably contains, among other elements, a boiler, a flow meter, and a low pressure pump all connected in a common fluid path between the water reservoir 102 and the pod holder assembly 110. As explained further below, the pod holder assembly 110 may be removed in order to clean or replace the pod holder assembly 110. The pod holder assembly 110 may alternatively include a fluid nozzle which is pivotally mounted on the apparatus 100 such that different sized cups or mugs may be accommodated.

The apparatus preferrably has a base 115 that may support up to two coffee cups 117. As would be readily understood, apparatus 100 may be used with vessels other than coffee cups. The base may also include a drain cover and overflow reservoir to catch fluid not caught by coffee cup 117. A power switch 120 selectively connects the apparatus 100 to an electrical power supply, such as main power. As would be known to those skilled in the art, apparatus 100 will include one or more voltage regulator/transformers as needed to supply the appropriate power to the various electrical components of the apparatus. As shown in FIG. 1, power switch 120 is preferrably implemented as momentary contact switch to facilitate “auto shut-off” functionality (in association with a controller (not shown)) as is common in household appliances today.

As also shown in FIG. 1, switches 122 and 124 are preferrably provided to allow the end user to select between two volumes (e.g. 5 ounces and 8 ounces) of brewed fluid to be produced. These two switches are operably connected to a first circuit that controls the metered fluid output of the flow meter based on this user selection. This first circuit primarily consists of a microprocessor or discrete circuit that monitors for the actuated one of switches 122 and 124 and controls the flow meter accordingly. While additional volume choices may be made available to the end user, it is also possible that a single volume of brewed fluid may be permanently set by the manufacturer. In this manner, apparatus 100 produces a selected volume of brewed fluid as opposed to prior known apparatuses which control the brewing process using a timer. These timed-control apparatuses produce a widely variable amount of fluid due to the grind size, roast color, and the mass of the foodstuff, among other potential variables, in the pod. As a general result, these variations in the timed-control apparatuses will unacceptably alter the taste profile of the resulting brewed fluid.

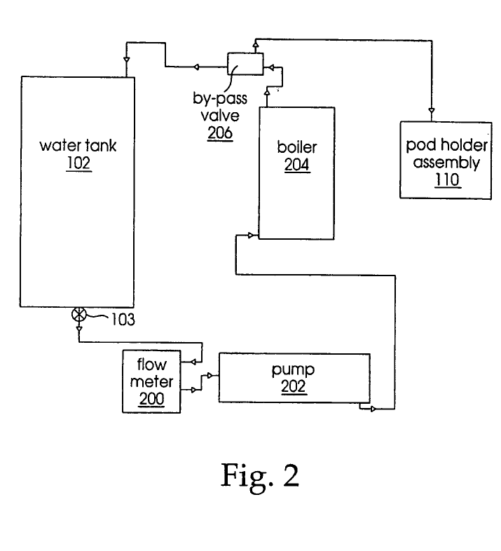

FIG. 2 shows a schematic diagram of the preferred fluid path of apparatus 100. This preferred fluid path includes flow meter 200, pump 202, boiler 204 and by-pass valve 206 connected between the water reservoir 102 and pod holder assembly 110. It is contemplated that the order of flow meter 200, pump 202, and boiler 204 in the fluid path may be changed without departing from the scope of the present invention.

Water reservoir 102 is in fluid communication with flow meter 200. Preferrably, the water reservoir is constructed to contain approximately 28 ounces of water (essentially enough for 3, 8 oz cups or 5, 5 oz cups of brewed liquid). An optional valve 103 may be disposed on the water reservoir 102 such that water will not flow from the reservoir unless it is properly connected to the fluid path. This allows removal of the water reservoir 102 for refilling in a sink. Optional valve 103 is preferrably a mechanical valve that is biased closed upon removal from the fluid path and remains open during fluid communication between the water reservoir 102 and the fluid path. Water reservoir 102 may additionally or alternatively have an open mouth to allow water to be poured into the reservoir without removing it from the rest of apparatus 100.

Flow meter 200 is essentially a switch that controls the volume of water that is fed through the fluid path. In the preferred embodiment, flow meter 200 has a housing that encloses a turbine with a magnet embedded therein. As water flows through the flow meter, the turbine rotates the magnet, which rotation is sensed by a hall effect sensor mounted in association with the flow meter housing. In this manner, a controller (not shown) can count the number of turns of the turbine. The number of turns corresponds to a volume of water flowed. Thus, once the turbine rotates a desired number of times, the desired volume of water has been flowed into the fluid path. As discussed above, the controller may store more than one preset volume of water such that the end user can select the amount of brewed fluid produced by apparatus 100.

Pump 202 is in fluid communication with both flow meter 200 and boiler 204. In one embodiment, pump 202 is an electric pump generating approximately 1.5 bars of pressure. In another embodiment, pump 202 generates approximately 3.5 bars of pressure. With 3.5 bars of pressure, it has been determined that apparatus 100 can produce acceptable crema from coffee pod 1100 (discussed below). It is contemplated that the fluid path, boiler, by-pass valve and flow meter of apparatus 100 can simply be built to accommodate this higher pressure allowing the apparatus to use a pump having either pressure. Moreover because this higher pressure is much lower than the pressure required to produce espresso (generally thought to be approximately 9 bars), this 3.5 bar pressure requirement does not significantly raise the cost of the fluid path above that required to safely support 1.5 bars of pressure. This makes dual pressure this construction practical. It is contemplated that apparatus 100 could use a pump that can produce both 1.5 and 3.5 bars of pressure. In such a case, a switch would be provided to select between these pressures. This switch could be made available only to the manufacturer or provided to the end user so as to allow selection of either pressure to achieve different taste profiles.

Boiler 204 is in fluid communication with the pump 202 and by-pass valve 206. Boiler 204 preferrably has a volume of approximately 340 c.c. (or 12 ounces). Boiler 204 is electric and preferrably quickly heats the water to a desired preset temperature. While it is possible that boiler 204 could be a steam boiler, the use of steam would increase the water requirements of apparatus 100 along with its safety requirements (to protect against the steam pressures generated in such boilers) and, thus is considered to be generally undesirable.

By-pass valve 206 ensures that the pressure in the fluid path does not exceed the nominal pressure selected for apparatus 100. So, in an embodiment allowing for two pressures (e.g. approximately 1.5 and 3.5 bars), the by-pass valve would be selected to vent any pressure in the fluid path sufficiently in excess of 3.5 bars to cause safety and/or structural concerns.

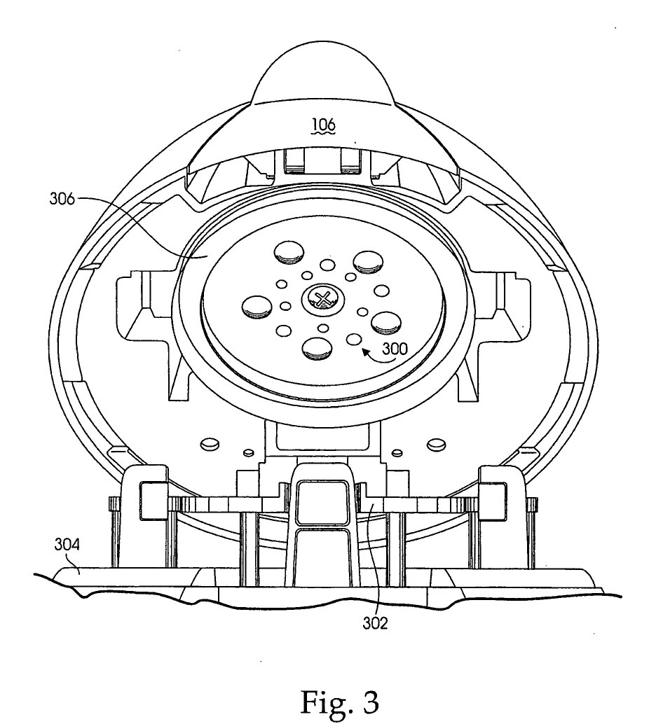

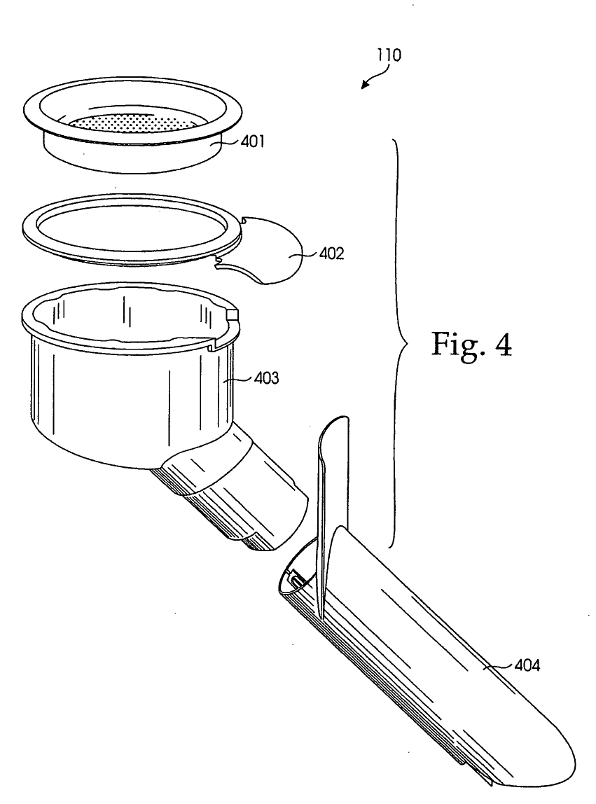

Hot water from the fluid path flows out through a shower 300 in brewhead 104. As shown in FIG. 3, the shower 300 has a plurality of apertures through which the hot water flows down onto the top of the pod holder assembly 110 (shown in detail in FIG. 4). The brewhead 104 is hingedly connected to the housing 112 (FIG. 1) to allow the end user to remove pod holder assembly 110 for placing a new pod with brewable foodstuff and for removing the assembly 110 for cleaning or replacement. Plastic bar 302 is biased upward, such that it is pushed downward as brewhead 104 is rotated down and forward into its closed position (shown in FIG. 1). In turn, plastic bar 302 moves a safety switch (not shown) between its open and closed positions. When the plastic bar 302 is in its up-most position, the safety switch is open, thus precluding the apparatus 100 from operating. This serves to substantially protect the end user from accidental scalding due to hot water flowing out of shower 300 while the brewhead 104 is open.

Latch 106 mechanically grabs a slot on the upper surface 304 of housing 112 to maintain closure. Gasket 306 encircles the circumference of the shower 300 and the top of pod holder assembly 110 to substantially preclude hot fluid from spreading out across upper surface 304 and possibly down the sides of housing 112 potentially producing an undesirable mess during operation.

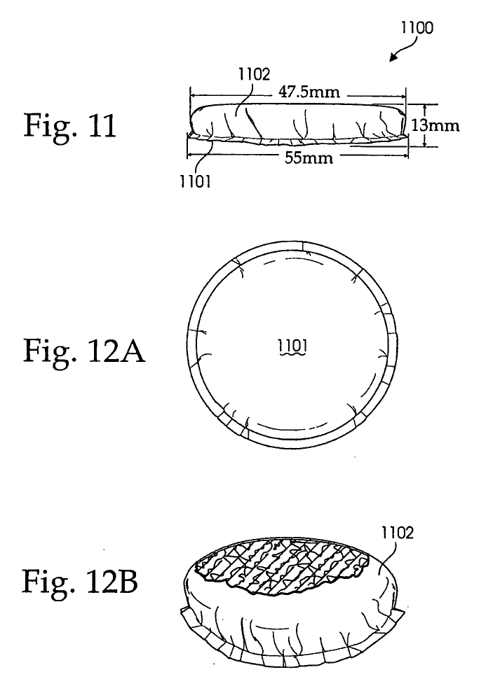

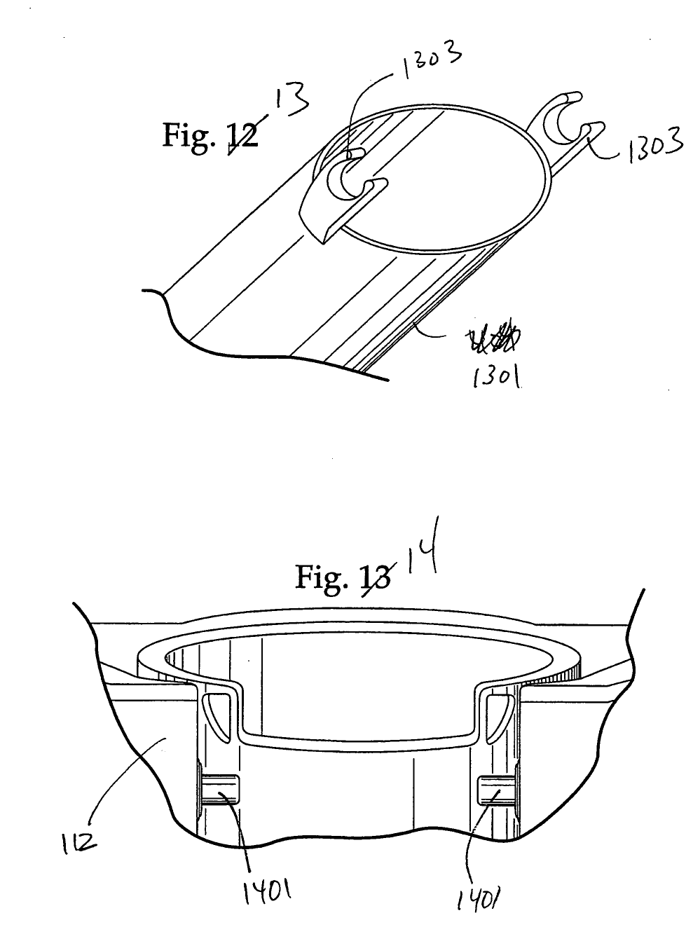

FIGS. 4 through 10 show various views of the pod holder assembly 110, which is capable of receiving pod 1100 (shown in FIGS. 11, 12A, and 12B). The pod holder assembly 110 includes pod cup 401, pod cup handle 402, fluid cup 403 and fluid nozzle 404.

Pod cup 401 receives and supports a pod 1100 (see FIG. 11) such that hot water pours onto the pod 1100 and brewed liquid flows out the sieved bottom of the pod cup. The pod cup 401 is formed of metal. The pod cup may have an integral or separate pod cup handle 402. Particularly where there is a separate pod cup handle 402, pod cup 401 preferrably has a flange that can be engaged by the pod cup handle to remove the pod cup 401 from the remainder of the pod holder assembly 110. Preferrably, pod cup handle 402 will be made from material that either does not conduct heat or does so poorly, thus allowing an end user to remove a pod soon after a brewing cycle by opening the brewhead 104, removing the pod cup 401 with pod cup handle 402, discarding the used pod, returning the pod cup 401 and handle 402 onto the rim of fluid cup 403 and placing a new pod into the pod cup. As shown in FIG. 4, the pod cup handle 402 may be shaped ergonomically to received a human figure on its underside.

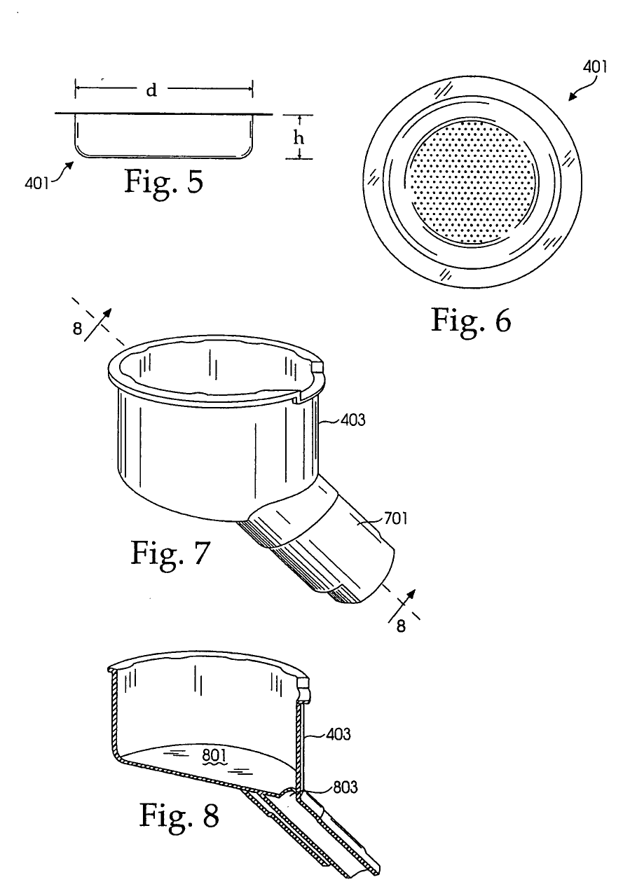

By selecting the diameter of pod cup 401, number of holes in the sieved bottom of pod cup 401 and the diameter of each hole in the sieve, the range of time that the hot water remains in contact with the brewable solids can be substantially controlled. The preferred embodiment of pod cup 401 is shown in FIGS. 5 and 6. The height of pod cup, “h,” is approximately 12.7 mm and its diameter, “d,” is approximately 47.63 mm.

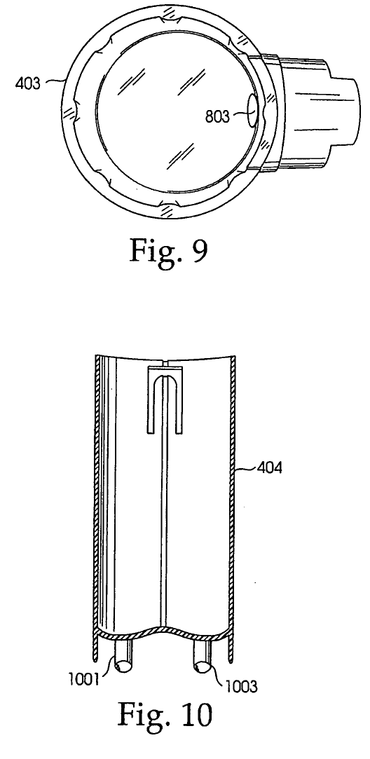

In the preferred embodiment, fluid cup 403 and fluid nozzle 404 together form a fluid conduit positioned to receive all of the fluid passing through the plurality of apertures in the sieved bottom of pod cup 401. This fluid conduit further conveys the received fluid into one or more coffee cups 117 (see FIG. 1). In the embodiment shown, fluid cup 403 also serves to provide a mounting platform for pod cup 401. While this arrangement simplifies the construction and ensures that nearly all (if not all) of the fluid passed through the pod is received by the fluid cup, other constructions are possible. As shown, in FIG. 7, fluid cup 403 preferrably has a notch for receiving the pod cup handle 402. As shown in FIGS. 8 and 9, fluid cup 403 is a simple cup having floor 801 and an outflow aperture 803 where the floor 801 preferrably slopes toward outflow aperture 803. The brewed fluid from pod cup 401 flows down through the plurality of holes in the sieve hitting the floor 801, which directs the fluid flow toward the outflow aperture 803 and out toward one or two waiting coffee cups via the fluid nozzle 404. In the embodiment shown, fluid nozzle 404 slides over the nipple 701 on fluid cup engaging it positively, but allowing for disengagement of the fluid nozzle 404 from nipple 701 to clean and/or replace of same. As shown in FIG. 10, fluid nozzle 404 is a simple tube having two spouts 1001 and 1003 that are sufficiently spaced-apart to allow flow into two separate cups of coffee, but sufficient close together to allow the flow from both spouts to feed into a single coffee cup.

As previously explained, in a preferred embodiment, the pod holder assembly 110 may be removed or replaced. In an embodiment where replacement is possible, a user may select different pod holder assemblies 110 for different purposes. For example, for coffee, it is common for a user to have a shorter cup 117 such as a coffee mug. In this case, the coffee may splash out if the fluid nozzle 404 is too far away from the cup 117. Thus, it is preferable to have a pod holder assembly 110 with a longer fluid nozzle 404 so as to bring the coffee closer to the cup as the fluid leaves the nozzle 404. On the other hand, for drinking iced tea, it is more common to use a taller glass. In such a case, a long fluid nozzle 404 may be too long to allow the glass to fit under the pod holder assembly 110 to catch the brewed fluid. Thus, a pod holder assembly 110 having a shorter fluid nozzle 404 to accommodate a tall glass 117 may be used.

Additionally, it may also be desirable to simply have two or more interchangeable fluid nozzles 404a and 404b of the same (or differing) length, with associated fluid cups 403a and 403b, pod cup handles 402a and 402b and pod cups 401a and 401b. For instance, one nozzle could be used for coffee beverages and another for tea beverages. In this way, the undesirable introduction of a “coffee taste” into the brewed tea beverages may be avoided. In one embodiment, the different interchangeable fluid nozzles 404a and 404b may be differentiated by some indicia of distinction, for example a descriptive label or color.

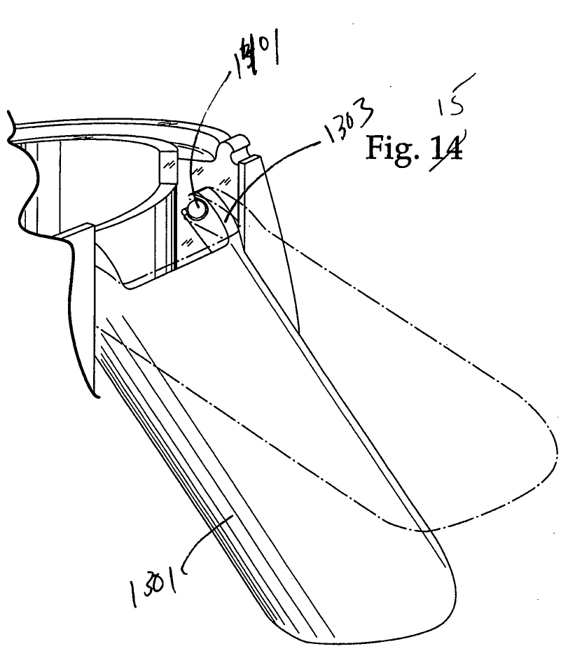

FIGS. 13-15 illustrate an alternative embodiment, wherein the fluid nozzle 404 may be pivotally coupled to the front part of the housing 112 so as to be able to accommodate different sized cups or mugs. FIG. 13 shows the top part of this alternative fluid nozzle 1301. The fluid nozzle 1301 includes two attachment portions 1303 for mounting on the housing 112 of the brewing apparatus 100. These attachment portions 1303 are shaped so as to provide a mechanical fit over respective mounting posts (1401 in FIG. 14) of the housing 112. As illustrated in FIG. 14, the mounting posts 1401 are located such that the fluid nozzle 1301 may be placed directly beneath the fluid cup 403 (not shown in FIG. 14) so as to form a form a fluid conduit positioned to receive all of the fluid passing through the plurality of apertures in the sieved bottom of pod cup 401 (not shown in FIG. 14) as described with respect to FIG. 4. This fluid conduit further conveys the received fluid into one or more cups 117 (see FIG. 1). It is preferred in this embodiment that the friction fit between the attachment portions 1303 and the mounting posts 1401 is such that the fluid nozzle 1301 is pivotally mounted to the mounting posts 1303.

With this embodiment illustrated in FIGS. 13-15, the fluid nozzle 1301 would preferably be in its lowest position when a short cup 117 is placed beneath, but may be pivoted upward to accommodate a taller cup such as a conventional iced-tea glass. This relative position of the fluid nozzle 1301 is illustrated in FIG. 15.

FIGS. 11, 12A and 12B provide various views of a preferred coffee pod 1100 for use in the apparatus 100. Coffee pod 1100 is formed of filter material (preferrably paper) and contains a mass of ground, brewable foodstuffs 1200 (FIG. 12B). The ground, brewable foodstuff 1200 is preferrably coffee. As shown in FIGS. 11, 12A and 12B, pod 1100 is a pie-shaped unit. This pie-shape is formed by adhering a planar top sheet 1101 and a substantially cup shaped bottom sheet 1102. Preferably, these sheets are formed of 19 gsm Waterjet paper. This paper is commonly used in the manufacture of tea bags. This pie-shape allows for a greater mass of ground foodstuffs to be used in apparatus 100 resulting in a desired taste profile.

In the preferred embodiment, the pod has the dimensions shown in FIG. 11. These dimension allow for a selected mass of ground, brewable foodstuffs in the range of approximately 9.3 grams to 9.9 grams. Various blends of coffee are presently intended for use in apparatus 100:

| | | | | Caffeinated | |
|---|---|---|---|---|---|
| | | | | plus 3% | |
| Coffee Type | Caffeinated | Caffeinated | Caffeinated | flavoring | Decaffeinated |
| Weight | 9.7 g +/− .2 g | 9.5 g +/− .2 g | 9.7 g +/− .2 g | 9.7 g +/− .2 g | 9.7 g +/− .2 g |
| Roast Color | 52 +/− 2 | 31 +/− 2 | 45 +/− 2 | 50 +/− 2 | 45 +/− 2 |
| (Agtron Model | | | | | |
| E-10) | | | | | |
| Moisture | 4% +/− .5% | 3% +/− .5% | 4% +/− .5% | 4% +/− .5% | 4% +/− .5% |
| (Computrac | | | | | |
| Moisture Meter) | | | | | |
| Soluble Solids | 1.01 +/− .05 | 1.07 +/− .05 | 1.1 +/− .05 | 1.07 +/− .05 | 1.01 +/− .05 |
| (Rasher & | | | | | |
| Betzold | | | | | |
| Hydrometer) | | | | | |
| Residual Sugar | 1.1 +/− .1 | 1.1 +/− .1 | 1.3 +/− .1 | 1.3 +/− .1 | 1.0 +/− .1 |
| (Refracto Meter) | | | | | |
| Grind Type | A | A | A | B | A |

Grind type is determined by using an Alpine Analysis with 20 inches of vacuum. Type A has 0% at #16 Screen; 1% at #20 Screen; 6% at #30 Screen; 45% at #40 Screen; 70% at #50 Screen; 0% at #100 Screen and 0% at the pan. Type B has 0% at #16 Screen; 1% at #20 Screen; 13% at #30 Screen; 54% at #40 Screen; 76% at #50 Screen; 0% at #100 Screen and 0% at the pan.

Coffee flavoring is achieved by spraying the coffee with oils and extracts, or dusted with powders. 3.0% equates to 3.0 ounces of flavoring for every 1 lb. of roasted coffee.

Apparatus 100 achieves a method of brewing foodstuffs. The end user places pod 1100 containing ground, brewable foodstuffs 1200 into pod holder 402. The measured volume water is heated by a boiler. The apparatus pumps a metered volume of water at a selected fluid pressure. In one method, the apparatus first pumps a small amount of water to pre-infuse the pod. This pre-infusion involves pre-wetting the pod 1100 with water to assist in brewing, which preferrably occurs for 5 seconds. Eventually, the heated metered volume of water at the selected fluid pressure is fed to the pod located in the pod holder resulting in a fluid having a desired amount of soluble solids. That brew fluid is passed into a coffee cup.

While various embodiments of the application have been described, it will be apparent to those of ordinary skill in the art that many more embodiments and implementations are possible that are within the scope of this invention. Accordingly, the invention is not to be restricted except in light of the attached claims and their equivalent.

1. An apparatus for brewing ground, brewable foodstuffs, the apparatus comprising:
a water reservoir having an output;
a boiler; and
a plurality of interchangeable pod holder assemblies, each pod holder assembly comprising a pod holder capable of receiving a pod formed of filter material and containing a mass of ground, brewable foodstuffs, the pod holder having a sieved bottom, and a fluid conduit positioned to receive fluid passing through the sieved bottom and to convey the fluid into one or more cups;
wherein the boiler and the water reservoir are connected in a common fluid path with a pump that produces a fluid pressure in the common fluid path and wherein the fluid path begins at the output of the water reservoir and the pod holder is located so as to receive the metered volume of water from the common fluid path.

2. The invention according to claim 1 further comprising a circuit for controlling the fluid pressure produced by the pump.

3. The invention according to claim 2 wherein the fluid pressure produced by the pump is based on user selection of one of at least two discrete pressures.

4. The invention according to claim 1 further comprising a second circuit controlling the fluid pressure produced by the pump.

5. The invention according to claim 4 wherein the fluid pressure produced by the pump is based on user selection of one of at least two discrete pressures.

6. The invention according to claim 1 wherein the water reservoir is selectively removable from the common fluid path, the water reservoir further including a valve selectively sealing the output of the water reservoir.

7. The invention according to claim 1 further comprising a pod, the pod including:
a selected mass of ground, brewable foodstuffs,
a filter material surrounding the selected mass of ground, brewable foodstuffs,
wherein the selected mass of ground, brewable foodstuffs and the filter material form a pie-shaped unit.

8. The invention according to claim 7 wherein the selected mass of ground, brewable foodstuffs is in the range of approximately 9.3 grams to 9.9 grams.

9. The invention according to claim 8 wherein the filter material includes a planar top sheet and a substantially cup shaped bottom sheet wherein the top and bottom sheets are adhered together.

10. The invention according to claim 9 wherein the bottom sheet circumscribes a diameter of approximately 47.5 millimeters and a height of approximately 13 millimeters.

11. The invention according to claim 1 wherein the relative length of one or more of said fluid conduits is preselected by a user based on a height of said one or more cups.

12. The invention according to claim 1 wherein at least one of said interchangeable pod holder assemblies is selected by a user based on a particular ground, brewable foodstuff to be brewed.

13. The invention according to claim 1 further comprising a a flow meter providing a metered volume of water.

14. The invention according to claim 13 wherein the flow meter is further connected with the boiler and the water reservoir in said common fluid path with the pump.

15. The invention according to claim 14 further comprising a circuit for controlling the metered fluid output of the flow meter based on user selection of one of at least two discrete volumes.

16. The invention according to claim 1 wherein at least a portion of one or more of said interchangeable pod holders includes an indicia of distinction.

17. The invention according to claim 16 wherein said indicia of distinction is either a descriptive label or a color.

18. A method of brewing ground, brewable foodstuffs comprising:
selecting one of a plurality of pod holder assemblies;
placing a pod containing ground, brewable foodstuffs into a pod holder;
pumping a metered volume of water at a selected fluid pressure;
heating the metered volume of water;
feeding the heated metered volume of water at the selected fluid pressure to the pod in the pod holder resulting in a fluid having a desired amount of soluble solids; and
passing the fluid having a desired amount of soluble solids into a cup.

19-29. (canceled)
